(19) United States
(12) Patent Application Publication
(10) Pub. No.: US 2014/0263278 A1
(43) Pub. Date: Sep. 18, 2014

(54) SOLAR SELECTIVE MULTILAYER COATING

(71) Applicants: Solarno, Inc., Coppell, TX (US); The Board of Regents of the University of Texas System, Austin, TX (US)

(72) Inventors: Anvar A. Zakhidov, McKinney, TX (US); Vladimir A. Pozdin, Dallas, TX (US); Fatemeh Hassanipour, Plano, TX (US); Sergey Darmanyan, Plano, TX (US); Alexios Papadimitratos, McKinney, TX (US)

(73) Assignees: Solarno, Inc., Coppell, TX (US); The Board of Regents of the University of Texas System, Austin, TX (US)

(21) Appl. No.: 14/214,799

(22) Filed: Mar. 15, 2014

Related U.S. Application Data
(60) Provisional application No. 61/786,430, filed on Mar. 15, 2013.

(51) Int. Cl. F24J 2/48; H05B 3/10; F24J 2/46

(52) U.S. Cl. CPC F24J 2/485; F24J 2/4652; H05B 3/10
USPC 219/472; 428/408; 428/137; 428/136; 428/323

(57) ABSTRACT

The present invention provides a method for making a highly efficient and inexpensive solar selective coating. Coating consists of various carbon nanotube sheets composite layers, each performing a specific function by incorporating functional materials and components with proper structure. Joule heating of the described solar selective coating allows for efficient functionality even when solar energy is not available.

### CROSS-REFERENCES TO RELATED APPLICATIONS

This Application claims the benefit under 35 U.S.C. §119(e) of U.S. Provisional Patent Application No. 61/786,430 filed Mar. 15, 2013 which is incorporated herein by reference in its entirety as if fully set forth herein.

### STATEMENT REGARDING FEDERALLY-SPONSORED RESEARCH OR DEVELOPMENT

This invention was made with government support under DOE Phase I STTR Grant No. 87938T12-I awarded by the Department of Energy. The government has certain rights in the invention.

### BACKGROUND OF THE INVENTION

1. Field of the Invention

The present invention is directed to a method and materials for making an effective selective coating on a solar energy collector element and in particular, an element that displays superior properties in selective solar light absorption, heat transfer, heat storage, advanced functionality, and is inexpensive to manufacture.

2. Description of the Related Art

A number of systems have been developed to collect solar energy and convert it into an alternative form of energy, electricity, or use the solar energy to perform work, such as in the case of a solar water heater, or to heat water for use in industrial and commercial applications and/or domestic use in private houses.

An important component of all these systems is the solar collector, which absorbs the visible light and heat energy (infrared radiation) from the sun, transfers it to heat in some light-to-heat conversion material, and conducts further heat to a certain transfer medium, which delivers the heat as hot water to a house or to a heat storage unit (e.g. tank with hot water). One example of a type of an advanced and highly effective type of solar water heater is an evacuated tube collector (ETC), see FIG. 1, made of two concentric glass tubes 12 separated by vacuum 14, which reduces the heat loss due to the absence of convection and minimal thermal conductivity in vacuum. The outside of the inner tube is coated with the selective coating 10 the purpose of which is to absorb all photons, which carry the solar energy. This kind of solar collector transfers heat through a thin layer of “black” absorber-coated glass of the inner vacuum tube to a heat transfer fluid, typically water, which can be either direct or indirect in operation via heating and evaporating of the secondary liquid inside the so-called heat pipe.

Modern selective coatings are made using cermet (a metal/ceramic composite) to absorb solar energy. Such coatings have been shown to exhibit solar absorbance over 0.9, but this comes at a cost of fabrication. Commonly used cermet in commercial evacuated tube solar collectors is aluminum-nitrogen (Al—N) thin film coating (on top of copper or stainless steel thin films) produced by magnetron sputtering performed in enormous size vacuum systems to accommodate the standard 2 meter long tubes. For increased light absorption, solar selective layer made up of composition gradient cermet layer has been proposed, but this would require very careful control over the sputtering process. Alternatively, multiple layers with varying compositions of cermet have been used for improved solar selective coatings. Recent high efficiency and high temperature solar selective coating are made up of 12 sputtered layers. Such complex coatings are still inefficient solar absorbers as compared to absorption by an ideal “black body,” while high manufacturing costs are among some of the limitations of these methods.

A step in the right direction has been recently made by the proposal to use carbon nanotubes (CNTs) as a solar selective coating. Carbon allotropes have been used through the years for selective coatings and have changed with the development of various forms of carbon from amorphous carbon soot to carbon nanotube arrays. Single carbon nanotubes are known as excellent thermal conductors, outperforming even copper metal. For practical applications, carbon nanotubes can be made into sheets or arrays, which can be easily transferred onto any surface. However, the overlap between individual carbon nanotubes (which can be produced only with finite length in range of 5-10 microns to 100s of microns) in such forms is poor and therefore the thermal conductivity is reduced, as compared to that of individual nanotubes. Properties of carbon nanotubes, particularly of the vertically aligned arrays of single wall CNTs, are similar to a perfect black body, and are advantageous for absorbing most of the solar radiation, unfortunately the black body properties also means high emissivity and heat losses due to re-radiation. Therefore utilization of solely carbon nanotube sheets or arrays (also known as CNT-forests) for solar selective coating has a significant benefit for absorptions, but suffers from a number of disadvantages.

Another limitation of current solar water heater systems is that the time of hot water consumption does not always correspond to the peak of incoming solar energy, as is at night, early morning, or on a cloudy day, when insufficient solar energy is available to heat the water. This requires an addition of a booster heating system to provide additional heating capability at any given time of day. Alternatively, there have been some designs of new solar water heaters, which accomplish this task. Both of these methods require additional hardware and therefore increased costs. Thus, there exists a need to develop a solar selective coating that does not suffer from the disadvantages of prior art systems.

### SUMMARY OF THE INVENTION

An embodiment of the invention is directed to a multifunctional solar selective coating using carbon nanotube (CNT) sheets composites, which accomplish simultaneously several important and distinct tasks of: (1) enhanced photon transmission through uppermost layer (with minimal light loss due to reflection), (2) enhanced photon trapping in second layer (with suppressed photon scattering backwards), (3) effective photon to heat conversion, (4) heat accumulation in some media, (5) effective heat transfer through substrate to water or a heat pipe, and (6) enhanced reflection in infrared for reduced emissivity. Additional functionality of the multifunctional coatings of present invention enables heat storage in a specially designed sub-layer and/or additional heat generation directly on the coating.

### BRIEF DESCRIPTION OF THE DRAWINGS

FIG. 1 is a through, side view of an evacuated solar tube collector in accordance with the prior art;

FIG. 2 is a schematic of birolling deposition process of any functional material into CNT sheet and formation of functional layer for heat management onto the carbon nanotube sheet in form of nanostructured composites in accordance with the prior art;

FIG. 3 is a schematic, side view of the solar selective coating made up of six functional layers;

FIG. 4 is a schematic, side view of the solar selective coating made up of five functional layers;

FIG. 5 is a schematic, side view of the solar selective coating made up of four functional layers;

FIG. 6 is an example of structure composition of the super transmission layer;

FIG. 7 is an example of the multifunctional selective layer coating with schematics of each layer composition, providing the required functionality;

FIG. 8 is a schematic, side view of the collector made from patterned metal on glass, which would allow the selective coating described here to function as electric heater;

FIG. 9 demonstrates the reflectivity of 5 carbon nanotube layers, deposited with parallel (II) and 90 degree offset (X) alignment of successive layers. Commercially available Al—N coating and an overlay of solar radiation spectrum on Earth (AM 1.5) are provided as references;

FIG. 10 is a diagram obtained by experimental data and showing the comparison between the reflectivity spectra of CNT coatings and commercial aluminum nitrogen (Al—N) coating;

FIG. 11 is a diagram obtained by experimental data and showing the comparison between the CNT selective coatings with and without PCM filler;

FIG. 12 is an example of realized Joule heating functionality in solar collector with carbon nanotube selective coating;

FIG. 13 is a diagram obtained by experimental data and showing the operation of solar collector by Joule heating;

FIG. 14 is a diagram calculated from experimental data and showing the efficiency of Joule heating functionality;

FIG. 15 shows a schematic diagram of the composite; and

FIG. 16 shows absorption of the excessive energy by the PCM by phase transition (melting) and releasing the absorbed energy later or when the peak has passed (solidification)when a temperature increases to more than melting point of the PCM.

### DETAILED DESCRIPTION OF EXEMPLARY EMBODIMENTS

An embodiment of the invention is directed to a solar selective coating made up of spinnable carbon nanotube sheets based composite layers. In certain embodiments, the outermost layer on the very top is made of highly electrically conductive films, such as graphene flakes, overcoated on the CNT sheet network with slits and holes of sub-wavelength sizes for enhanced transmission of solar light photons inside the bulk of the selective coating.

In certain embodiments, a vertically aligned carbon nanotubes are used as an outer layer (below the super transmission layer with holes) for photon capture, and the length of the carbon nanotubes is in the range of 50 to 500 μm.

In certain embodiments, the solar selective coating comprises of undensified carbon nanotube sheets or CNT composite layers that are used as the outer “photon trapping” layer with enhanced diffusive scattering of light from randomly oriented CNT bundles for enhanced for photon capture. In other embodiments, the densified carbon nanotube composite layers are used as the photon-to-heat conversion layers with enhanced heat capacitance.

In certain embodiments of the invention, particles with high reflectivity in low range infrared (IR) bands and non-absorbing in visible to near IR bands are incorporated into the carbon nanotube composite layer to capture the re-radiation energy.

In an embodiment of the invention, the carbon composite layers and phase change materials (PCM) in the form of polymeric microcapsules filled with e.g. paraffin or other high latent heat material are used as the heat accumulation layer. In other embodiments, the carbon composite layers and highly thermally conducting particles, such as graphite flakes and polycrystals are used as the heat transfer layer.

In typical cases, the thickness of the composite layers ranges from 5 to 20 layers.

In certain embodiments, the solar selective coating has electrical connections for the purpose of generating heat by the passing of electrical current. In certain embodiments, thermally conducting epoxy is used between the carbon nanotube layer and glass tube.

The solar selective coating has layers of multiple functionality, which can be separated into different functions, such as: a layer for high IR reflectivity, layer with the function of super transmission of photons through sub-wavelength holes, layer with the function of enhanced trapping of photons, layer with the function of converting them to heat, layer with the function of accumulating said heat in PCM layer, and layer with the function of transferring heat to the desired surface. Each of these functions can be realized by a separate composite layer made with carbon nanotube sheets in order to maximize its efficiency. The disadvantages of carbon nanotube sheets can be suppressed by utilizing a filler material with desired functionality and making composite layers as shown in FIGS. 3, 4, and 5 to accomplish each task of the selective coating.

The process of birolling is easily applied to carbon nanotube selective coating deposition as shown in FIG. 2. Carbon nanotube sheet 20 is wrapped around a rotating drum 26, which can also be traversed laterally to allow coating along the length of the drum. Composite material is deposited onto the carbon nanotube sheet 20 from an aerogel 22 or alternative method prior to being wrapped around the drum. As a result, carbon nanotube composite material 24 is then wrapped around the drum 26. It has been shown that as high as 98% weight fraction of composite material can be added to carbon nanotube sheet. Evacuated tube solar collector FIG. 1 can replace the rotating drum 26 and eliminate the subsequent need to transfer the composite material from the drum.

Referring to FIGS. 3, 4, 6 and 7, a solar selective coating is made up of anti-emission layer 28, super transmission layer 29, photon trapping layer 30, photon conversion layer 32, heat accumulation layer 34, and/or heat transfer layer 36 deposited on top of a substrate 38 made of glass or metal. All or any of the layers of the selective coating can be made using spinnable CNT sheets as a basis composite.

Outer most layer of the selective coating serves to reduce the emissivity losses by having high reflectivity in low range infrared, typically above 2 μm. This is accomplished with low emissivity additives or materials. Black nickel is known to have low emissivity and can be applied to the carbon nanotube coating by electroplating or birolled in powder form. Alternatively, similar materials can be applied to the carbon nanotube coating and processed, such as anodized aluminum. Anti-emission layer is also realized by utilizing sol-gel oxides, made popular by organic photovoltaics. Oxide material with low emissivity can be easily deposited on carbon nanotube coating from sol-gel solution or another method. High thermal stability of carbon nanotubes is quite favorable for the high curing temperatures of most sol-gels and is an intricate property for the vacuumation process of evacuated tube collectors.

The second outer most layer of the selective coating is to be the photon super transmission layer 29. This layer provides the enhanced transmission of photons of solar spectrum into the second layer, the photon trapping layer 30. The phenomenon is related to the enhanced transmission of photons through sub-wavelength holes inside highly conductive thin films. The mechanism of this super transmission is based on the transformation of photons into surface plasmons on first surface, then coupling of the first surface with the second surface, and emission or radiation of secondary photons from plasmons in the lower layer into the photon trapping layer 30, as shown in FIG. 7. FIG. 6 schematically shows the structure of the super transmission layer made of few layers of graphene with sub-wavelength holes. This can be created by having one layer of carbon nanotube sheets coated with overlapping and partly non-overlapping graphene flakes. Such coating creates little holes 50-200 nanometers in size, which is smaller than the typical wavelength of the solar light; at the same time the holes are of different sizes, which allows super transmission of different parts of the spectrum. In addition, the super transmission layer will also function as the top cap of the solar selective coating, which will enhance the trapping of photons inside the “photon trapping” layer 30. In one example, the upper most layer which is made of a very thick sheet of slightly densified carbon nanotube sheets with embedded layers of silver flakes or some other conductive flakes, which will also work for the purpose of super transmission through sub-wavelength holes.

The photon trapping layer 30 is utilized under the super transmission layer 29 or as the outer most layer without the super transmission layer 29, FIGS. 3, 4. In one embodiment this layer would be made up of vertical array of CNTs, which would allow for more than 99% of solar light to be absorbed. In embodiment 2, this layer would be made up of undensified carbon nanotube sheets applied by birolling. Due to the alignment of carbon nanotubes in the drawn sheet and the associated polarization, it is ideal to form successive layers at a near 90 degree angle, in a mesh pattern, in order to maximize photon capture. Carbon nanotubes have near black body properties, which are perfect for the absorption of the solar energy, but the re-radiation of the energy is also high. In order to recapture the long range IR radiation without losses in the solar spectrum, glass microspheres or similar material can be incorporated into the CNT sheet composite. Vertically aligned CNT array in the embodiment 1, is to contain CNT 50 μm to 500 μm in length, and preferably 100 μm. The photon trapping layer 30 made up of undensified carbon nanotubes can consist of 5 to 20 layers, and preferably 10 layers.

The photon conversion layer 32 is made up of densified carbon nanotubes sheets. This layer is similar to embodiment 2 of the photon trapping layer 30, but is treated with an alcohol, water, solvent, or vapor in order to collapse the sheets onto themselves and increase the overlap between individual carbon nanotubes in the sheets and improve the thermal conductivity. Such process would cause the underlying layers to densify also, therefore we do not mention densification of the underlying layers and it is understood that it can be carried out separately or simultaneously. The photon conversion layer 32 can consist of 5 to 20 layers, and preferably 10 layers.

The heat accumulation layer 34 is realized by making a composite of carbon nanotube sheets and phase change materials (PCM) through the process of birolling as shown in FIG. 2. A schematic configuration of the composite is shown in FIG. 15. Examples of phase-change materials include salt hydrates, certain hydrocarbons, and metal alloys. Among these materials, paraffin is the most promising one for thermal management in industrial applications. Phase Change Materials (PCM) with high latent heat capacity, absorb the excessive energy (melting) during the day, and release the absorbed energy during the night (solidification). When a temperature increases to more than melting point of the PCM, it absorbs the excessive energy by phase transition (melting) and releasing the absorbed energy later or when the peak has passed (solidification) (FIG. 16). Paraffins offer important advantages over other PCMs. They have large spectrum of latent heats (220˜270 kJ/kg) and melting points (5.5˜80° C.). Therefore, the PCM melting and solidifying temperature range can be easily matched with the system's operating temperature for the phase-change process to be effective. Another advantages of paraffin PCMs are their: (1) physical properties (high density, small volume change, and low vapor pressure), (2) chemical properties (long-term chemical stability, compatibility with materials of construction, no toxicity, no fire hazard) and (3) their low cost and availability. In this embodiment, the PCM is a paraffin filler in the form of microencapsulated particles with a melting temperature matched to the system configuration. As the selective coating absorbs solar energy, the PCM inside the heat accumulation layer 34 would change from solid to liquid phase and store energy in the form of latent heat. During decreased incident solar energy, such as cloud cover, or nightfall, PCM would undergo a phase transition and the stored energy will be released. In order to keep the PCM inside the layer, particles are to be encapsulated in microcapsules. The heat accumulation layer 34 can consist of 5 to 20 layers of CNT sheets with incorporated PCM microcapsules, and preferably 10 layers.

Another layer of the proposed solar selective coating, as shown in FIG. 3, 4, 5, 7 is the heat transfer layer 36, which is realized by making a composite of CNT sheets and heat transfer nanoparticles. Highly conducting and inexpensive nanoparticles, such as graphene, can be utilized in this layer. Best results can be achieved by dip coating carbon nanotubes in a solution of nanoparticles to allow the residual solvent or water to evaporate and form a dense composite of CNT sheets and nanoparticles. The heat transfer layer can consist of 5 to 20 layers, and preferably 10 layers.

Depending on the application of the selective coating, one can come up with any combination of the described five layers, even with other selective layer technology, and it is to be understood that modifications and variations may be resorted to without departing from the spirit and scope of the invention as those skilled in the art will readily understand. Such modification and variations are considered to be within the purview and scope of the invention and the appended claims.

Carbon nanotubes also function as fast and efficient Joule heaters, and it is possible to use the selective coating on the solar collector as an electric heater by passing current through the layer. This can be accomplished by depositing the selective coating described here on a glass/copper coating, which is typical for high temperature collectors, as demonstrated in FIG. 8. The copper coating 16 is to be discontinuous and can be divided in various length sections along the coating in order to achieve desired current rating for the system. Electrical connections 18 can be made to the copper coating directly. Carbon nanotube coating can be heating very quickly using Joule heating, allowing the heat pipe to operate more quickly and efficiently (due to reduced cooling losses), as compared to operation under solar energy. This allows for early morning operation of the system to meet the morning demand for hot water.

An intricate element of the solar selective layer is the adhesion layer between glass and CNT layer. The thermal contact between these layers is improved through the use of thermally conducting paste or aerosol. In addition, the use of liquid glass significantly improves the performance of CNT composite layer selective coating. It is also possible to embed the CNT layer into glass through the use of zone annealing to soften the glass and allow CNT layer to become part of it.

### WORKING EXAMPLES

### Example 1

### Absorption of Carbon Nanotube Coating

In one example borosilicate glass substrates were coated with 5 undensified CNT sheet layers. One substrate was prepared with all CNT sheet layers having parallel (∥) alignment and other with successive layers having near 90 degree alignment difference (X). Due to the highly aligned nature of CNT sheets and the associated polarization effect, the X arranged coating has smaller reflectivity than ∥ coating. Both of these coatings significantly outperform a commercially available aluminum-nitrogen coating (Al—N), see FIG. 10. Such coating would be preferentially used on top of the solar selective coating in order to maximize absorption.

### Example 2

### CNT Solar Collector

In another example, an entire solar collector was made with CNT selective coating. Substrate with CNT forest was attached to a linear translation stage. A borosilicate glass tube with one closed and one flared end, made to the specification of the inner tube of the ETC, was attached to a variable speed rotating motor. A substrate with deposited CNT forest was mounted on a linear translation stage. CNT forest was pinched off and the removed sheet was attached to one end of the glass tube. By adjusting the linear stage translation and the motor rotation speeds, the CNT sheet was rolled onto the glass tube at an angle of 45 degrees with minimal overlap. By traversing the linear stage backwards and forwards, the tube was coated with 15 layers of CNT sheets with a near 90 degree overlap between the underlying layers. Upon completion, the carbon nanotube sheet was severed from the forest and isopropanol was dripped onto a rotating glass tube, in order to densify the selective coating. The coating was left on the rotating drum for 5 minutes in order to allow uniform densification and evaporation of solvent. The completion of densification was evident by graphite-like color of the selective coating, indicative of increased reflectivity due to the high degree of densification. Prepared inner collector tubes were fused at the flared end to outer borosilicate tubes. Fused tubes were evacuated to 10⁻⁶ Torr through an open end of the outer tube. After the glass outgassed, the outer tube was pitched off, FIG. 8.

Solar collectors were tested using a solar simulator and quantified using a thermocouple attached on the inside of the solar collector. Performance of CNT solar collectors was compared to commercially available Al—N collector, as well as the combination of both. From FIG. 10, it is clear that CNT solar collector is promising once the heat transfer issue is resolved, as described previously.

### Example 3

### CNT and PCM Composite Solar Collector

Alternative solar selective coating was created using a procedure similar to example 2, except microencapsulated paraffin particles were added to the CNT coating at various fractions. The paraffin used in this example is Octadecane C₁₈H₃₈ with melting point around 30° C. Coated tubes were tested in direct sunlight and quantified with thermocouple measurement of the inner temperature. The results show that addition of phase change materials has improved the heat transfer rate compared to the other tubes with no PCM (FIG. 11). Using PCM combined with carbon nanotube sheets leads to faster temperature rise. In addition, the resulting coating was shown to exhibit advantage over regular coating on a cloudy day. With intermittent cloud cover, the water temperature drop was smaller for the described solar selective coating with paraffin microcapsules. This coating was super duper for absorbing the solar radiation and converting it to heat.

### Example 4

### CNT Forest Grown on Glass

Embodiment one of the photon trapping layer described vertical nanotube forests on glass tube. In order to achieve this, borosilicate tube coated with an iron catalyst was placed in Chemical Vapor Deposition furnace and CNT forest was grown directly on the tube. Vertical orientation of CNTs maximizes the ability to absorb light by allowing the light to reflect multiple times within the forest. Thermal conductivity is also improved since heat is readily conducted along the axis of the tube into the glass.

### Example 5

### Solar Selective Coating with Enhanced Solar Absorption and Heat Transfer

Superior solar selective coating was created by utilizing multiple layer concepts described earlier. Substrate with CNT forest was attached to a linear translation stage. A borosilicate glass tube with one closed and one flared end, made to the specification of the inner tube of the ETC, was attached to a variable speed rotating motor. A substrate with deposited CNT forest was mounted on a linear translation stage. CNT forest was pinched off and the removed sheet was attached to one end of the glass tube. By adjusting the linear stage translation and the motor rotation speeds, the CNT sheet was rolled onto the glass tube at an angle of 45 degrees with minimal overlap. By traversing the linear stage backwards and forwards, the tube was coated with 5 layers of CNT sheets with a near 90 degree overlap between the underlying layers.

Without breaking the carbon nanotube sheet, graphite particles were added to the composition of the layers for 5 additional layers of the composite coating. Upon completion, the carbon nanotube sheet was severed from the forest and isopropanol was dripped onto a rotating glass tube, in order to densify the selective coating. The coating was left on the rotating drum for 5 minutes in order to allow uniform densification and evaporation of solvent. The completion of densification was evident by graphite-like color of the selective coating, indicative of increased reflectivity due to the high degree of densification.

On top of the created coating, new carbon nanotube sheet was attached from the forest and 5 more layers were completed similar to the previous technique. Densification process was not used for the final layer. The created coating has been shown to outperform the individual layers.

### Example 6

### Super Transmission Layer 1

To enhance the transmission of light into the “photon trapping” layer, we have created the uppermost transmission layer by covering the non-densified layer with very thin 3 layer lamination of carbon nanotubes coated using a special spray machine with graphene flakes prior to lamination. The size of the flakes is approximately 20-50 μm or larger and they are laminated in such fashion that there are some openings between the graphene flakes and the photons actually go through those slits and holes in each graphene flake. The mechanism of photon transformation into a surface plasmon and back to light from the other side of the layer by plasmon-photon transformation is explained in the description. Graphene flakes are known to have high conductivity and high mobility of several thousand cm²/Vs, which is characteristic for the recently discovered few layer graphene. This gives the sheet resistance of approximately 30-50 Ω/□, which corresponds to electron concentration for plasmons with energies relevant to solar spectrum for effective super transmission of light going through the sub-wavelength holes.

### Example 7

### Super Transmission Layer 2

Another example of super transmission uppermost layer involves a layer made of continuous sheets of multi-layer graphene with holes, which can be created on a very thin polymeric surface. After this film is laminated on the top of the photon trapping layer of the selective coating, the annealing by the resistive heating by electrical current evaporates the polymer and leaves the graphene flakes attached to the surface. So this example involves the sacrificial thin polymeric layer, which is for example poly(methyl methachrylate) (PMMA), polyvinyl chloride (PVC), or some similar low temperature degradable polymer film on top of which conductive film of graphene is created.

Based upon the teachings of this disclosure, those skilled in the art can fabricate solar selective coatings from similar materials having said properties. Such materials are contemplated as equivalent to the forms used for the method and apparatus of this invention.

The embodiment described herein is directed to the use of solar selective coating in an evacuated tube solar water heater. However, this is not intended to limit the use of the coating in any other kind of system including, solar water heater, solar power system, or air collector.

### Example 8

### Joule Heating

An embodiment of solar collector with Joule heating functionality is made with layers of CNT sheets coating the collector with electrical connections 18 to the selective coating, as in FIG. 12. Performance tests carried out on collector filled with 700 ml of water, a stirring rod to agitate the water, and thermocouple to measure the water temperature are shown in FIG. 13. The heating rate and the efficiency strongly depend on the power applied to the carbon nanotube coating. Typical measurements are shown for applied power of 85 W and 38 W. As expected, higher applied power, results in higher heating rate. By performing a polynomial fit to the heating curve, we calculated the heating efficiency of the process based on the applied power and amount of water in the collector. Plot of efficiencies versus ΔT, difference between initial and instantaneous temperatures, is shown in FIG. 14. An efficient heating process has to occur at a rate significantly faster than the system's cooling rate in order to minimize losses; therein by applying more power to the collector, we achieve higher efficiency. This embodiment demonstrates how Joule heating functionality can be used to achieve efficient operation of a solar collector, even without available solar energy, such as during morning demand.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are with the scope of this disclosure.

What is claimed is:

1. A solar selective coating made up of carbon nanotube multilayer composite having layers of different functionality.

2. The solar selective coating as claimed in 1, wherein the outermost layer is made of electrically conductive thin films with arrays of hierarchical small sub-wavelength size holes or slits, used for super transmission of solar light inside the inner layers of nanocomposite.

3. The solar selective coating as claimed in 2, wherein the arrays of vertically aligned carbon nanotubes are used below the super transmission layer for photon capture.

4. The solar selective coating as claimed in 1, wherein the arrays of vertically aligned carbon nanotubes are used as an outer for photon capture.

5. The solar selective coating as claimed in 3 or 4, wherein the length of CNT is in the range of 50 to 500 μm.

6. The solar selective coating as claimed in 1, wherein the undensified carbon nanotube sheets composite layers are used as the outer “photon trapping” layer for photon capture.

7. The solar selective coating as claimed in 6, wherein the thickness of the composite layer is in range of 5 to 20 layers.

8. The solar selective coating as claimed in 1, wherein particles with high reflectivity in low range IR and non-absorbing in visible to near IR are incorporated into or on top of carbon nanotube sheets composite layers to reduce emissivity of the coating.

9. The solar selective coating as claimed in 1, wherein the densified carbon nanotube sheets composite layers are used as the photon-to-heat conversion layer.

10. The solar selective coating as claimed in 9, wherein the thickness of the composite layer is in range of 5 to 20 layers

11. The solar selective coating as claimed in 1, wherein the carbon composite layers and phase change material (PCM) in the form of microcapsules is used as the heat accumulation layer.

12. The solar selective coating as claimed in 11, wherein the thickness of the composite layer is in range of 5 to 20 layers.

13. The solar selective coating as claimed in 1, wherein the carbon nanotube sheets composite layers and highly thermally conducting particles are used as the heat transfer layer with enhanced thermal conductivity.

14. The solar selective coating as claimed in 13, wherein the thickness of the composite enhanced thermal conductive layer is in range of 5 to 20 layers.

15. The solar selective coating as claimed 1, which has electrical connections for the purpose of generating heat by the passing of electrical current.

16. The solar selective coating as claimed in 1, wherein thermally conducting epoxy is used between the carbon nanotube layer and glass tube for improved thermal contact.
